(19) United States
(12) Patent Application Publication
(10) Pub. No.: US 2015/0155074 A1
(43) Pub. Date: Jun. 4, 2015

(54) Cables And Methods Of Making Cables

(71) Applicant: Schlumberger Technology Corporation, Sugar Land, TX (US)

(72) Inventors: Joseph Varkey, Sugar Land, TX (US); Sheng Chang, Sugar Land, TX (US); Qingdi Huang, Sugar Land, TX (US); Burcu Unal Altintas, Richmond, TX (US); Willem A. Wijnberg, Houston, TX (US)

(73) Assignee: Schlumberger Technology Corporation, Sugar Land, TX (US)

(21) Appl. No.: 14/096,863

(22) Filed: Dec. 4, 2013

(51) Int. Cl. H01B 7/18; H01B 7/16; H01B 13/00; H01B 9/06; H01B 13/06; H01B 7/14; H01B 9/00

(52) U.S. Cl. CPC H01B 7/1805; H01B 7/14; H01B 7/16; H01B 9/005; H01B 9/0605; H01B 13/06; H01B 13/0036

(57) ABSTRACT

A cable that includes outer cable jacketing located about a conductor layer. The conductor layer includes cable elements that are resistant to compression and a plurality of compression-resistant members.

### CROSS-REFERENCE TO RELATED APPLICATIONS

None.

### FIELD OF THE DISCLOSURE

The disclosure generally relates to cables and methods of making cables.

### BACKGROUND

In marine seismic activities, pulses from air guns are used to generate shock waves. The shock waves propagate into the substrate beneath the water. The shock waves are reflected back and are detected using sensors or the like.

The air guns are connected to a gun cable that has a high pressure hose and conductors for transmitting signals, such as power signals, telemetry signals, or combinations thereof.

The conductors in the gun cable are exposed to extreme compression forces. Some of compression forces are generated due to radially expansion of the hose due to high pressure. Other compression forces are generated by pulling forces on the cable causing the outer cable jacket to constrict. The compression forces combine together with conductor movement due to hose expansion or cable bending and often damage the conductors in the gun hose. Accordingly, a need exists for a gun cable that has a conductor layer that can withstand large compression forces.

### SUMMARY

An example cable includes a conductor layer. The conductor layer includes cable elements that are resistant to compression and a plurality of compression-resistant members. An outer cable jacketing is located about conductor layer.

An example gun-cable for use in marine-seismic activities includes a hose with an outer cable jacketing located thereabout. A conductor layer is located between the hose and the outer cable jacketing. The conductor layer includes conductors that are resistant to compression and a plurality of compression-resistant members.

An example method of making a gun-cable for use in seismic marine operations includes placing conductors about an internal hose, and placing compression-resistant members adjacent to some of the conductors. The compression-resistant members and conductors form a conductor layer. The method also includes placing an outer cable jacketing above the conductor layer.

### BRIEF DESCRIPTION OF THE DRAWINGS

FIG. 1 depicts an embodiment of a cable element that is resistant to compression.

FIG. 2 depicts another embodiment of a cable element that is resistant to compression.

FIG. 3 depicts another embodiment of a cable element that is resistant to compression.

FIG. 4 depicts yet another embodiment of a cable element that is resistant to compression.

FIG. 5 depicts another embodiment of a cable element that is resistant to compression.

FIG. 6 depicts another embodiment of a cable element that is resistant to compression.

FIG. 7 depicts another embodiment of a cable element that is resistant to compression.

FIG. 8 depicts another embodiment of a cable element that is resistant to compression.

FIG. 9 depicts an embodiment of a compression-resistant member.

FIG. 10 depicts an embodiment of a gun cable.

FIG. 11 depicts another embodiment of a gun cable.

FIG. 12 depicts yet another embodiment of a gun cable.

FIG. 13 depicts an embodiment of a cable.

FIG. 14 depicts an embodiment of a method of making a gun-cable for use in seismic marine operations.

### DETAILED DESCRIPTION OF THE INVENTION

Certain examples are shown in the above-identified figures and described in detail below. In describing these examples, similar or identical reference numbers are used to identify common or similar elements. The figures are not necessarily to scale and certain features and certain views of the figures may be shown exaggerated in scale or in schematic for clarity and/or conciseness.

An example gun-cable for use in marine-seismic activities includes a hose; an outer cable jacketing located about the hose; and a conductor layer located between the hose and the outer cable jacketing.

The conductor layer can include any number of cable elements that are resistant to compression.

An example cable element resistant to compression can include a core that is a stranded metallic conductive element. For example, the core can be a stranded copper wire, a copper-clad steel wire, a copper/magnesium alloy wire, or the like. An outer conductor jacket can be located about the core. The outer conductor jacket can be made from any material, such as polymeric material. Illustrative materials include fluoropolymers, polyolefins, polyarylether ketone family polymers, polyphenylene family polymers, olefin block copolymers, polypropylene cross linked with thylene propylene diene monomer (EPDM) rubber, or the like. The outer conductor jacket can be located about the core by extruding the outer conductor jacket over the core.

A reinforcement jacket can also be located about the core. The reinforcement jacket can be made from any structurally strong material. Illustrative materials include steel, steel alloys, or like materials.

The reinforcement jacket can be located about the core by using a pair of rollers to form a material strip into a tube. The tube can be formed around the outer conductor jacket. The tube can be seam welded and drawn down over the outer conductor jacket.

An example cable element resistant to compression can include a mini-quad core, an outer conductor jacket disposed about the mini-quad core, and a reinforcement jacket located about the core. For example, the reinforcement jacket can be placed about the polymeric outer jacketing.

An example cable element resistant to compression can include an optical fiber bundle. The optical fiber bundle can include a plurality of optical fibers. The optical fiber bundle can be located in an opening formed by two conductor halves. The conductor halves can be copper strips or the like. The conductor halves can have an outer conductor jacket located thereabout. A reinforcement jacket can also be located about the core. For example, the reinforcement jacket can be placed on the outer jacket.

An example cable element resistant to compression can include a core that includes four optical fiber assemblies. Each of the optical fiber assemblies can be located in an opening formed by two conductor halves. Each of the optical fiber assemblies can have a single optical fiber located therein. The core can have an outer jacketing and a reinforcement jacket disposed thereabout.

An example cable element resistant to compression can include a core that includes optical fiber assemblies with a single optical fiber. The core has an outer jacket and a reinforcement jacket disposed thereabout.

An example cable element resistant to compression can include a cable core that is a stranded metallic conductive element. An inner conductor jacket is located about the core, and a strength member layer is also located about the core. The strength member layer can be made from any strength members. For example, the strength member layer can include aramid yarn strength members or other suitable strength members. An outer conductor jacket is also disposed about the cable core. The outer conductor jacket can be a hard polymer or similar material.

An example cable element resistant to compression can include a mini-quad core with an inner conductor jacket, a strength member layer, and an outer conductor jacket located thereabout.

An example cable element resistant to compression can include a core with an optical fiber located in a shaped-wire assembly. An inner conductor jacket, a strength member layer, and an outer jacket can be located about the core.

An example cable element that is resistant to compression can include a core having four shaped-wire assemblies. Each of the shaped-wire tubes can have an optical fiber located therein. The core can have an inner conductor jacket, a strength member layer, and an outer jacket located thereabout.

An example cable element that is resistant to compression can include a core with a plurality of optical fibers located in a shaped-wire assembly. An inner conductor jacket, a strength member layer, and an outer jacket can be located about the core.

An example cable element that is resistant to compression can include a core having a single copper-clad steel or single copper/magnesium alloy conductive element. An outer conductor jacket can encase the core.

An example cable element that is resistant to compression can include a core having a mini-quad with copper-clad steel or copper/magnesium alloy conductive elements. An outer conductor jacketing can encase the core.

The conductor layer can also have a plurality of compression-resistant members. The compression-resistant members can include high-density polyethylene reinforced with fibers, nylon reinforced with fibers, or both. For example, the compression-resistant members can include a high-density polyethylene core and an outer layer. The outer layer can be any material. For example, the outer layer can be nylon reinforced with fibers or high-density polyethylene reinforced with fibers.

In an embodiment of the gun-cable, the conductor layer can include compression-resistant members that have a larger diameter than the outer diameter of the compression resistant conductors. In another embodiment of the gun-cable, the conductor layer can have compression-resistant members that have an outer diameter that is substantially similar to the outer diameter of the compression resistant conductors. Substantially similar as used herein can mean that the outer diameters of the conductors are within at least one hundredth of an inch of the outer diameters of the compression-resistant members.

An example gun cable for use in marine seismic operations can include a hose having a conductor layer and an outer cable jacket disposed thereabout. The conductor layer can be located between the hose and the outer cable jacket. The conductor layer can include any number of cable elements that are resistant to compression. The cable elements resistant to compression can be any cable elements disclosed herein.

In a non-limiting embodiment, the gun cable can have a conductor layer that can include conductors having large conductive elements forming the core thereof, and the core can have an outer conductor jacket and reinforcement jacket disposed thereabout. The conductor layer can also include mini-quad elements and optical fiber elements that do not have outer reinforcement jackets or strength layers disposed thereabout. The compression-resistant members can have an outer diameter that is equal to the outer diameters of the conductors. The compression-resistant members can be any combination of those disclosed herein.

In another non-limiting embodiment, the gun cable for use in marine seismic operations can have a conductor layer that includes cable elements having large conductive elements forming the core thereof, and the core can have an outer conductor jacket and reinforcement jacket disposed thereabout.

The conductor layer can also include mini-quad elements and optical fiber elements that do not have the outer reinforcement jackets or strength layers disposed thereabout. The compression-resistant members can have an outer diameter that is larger than the outer diameters of the cable elements. The compression-resistant members can be any combination of those disclosed herein.

In a non-limiting embodiment, the gun cable can have a conductor layer that includes various cable elements with cores that are encased by an inner conductor jacket, a strength member layer, and an outer conductor jacket. The strength member layer can include aramid yarn strength members or other suitable strength members. The conductor layer can also include compression-resistant members that have outer diameters that are substantially similar to the outer diameters of the conductors.

In another non-limiting embodiment, the gun cable can have a conductor layer that includes various cable elements with cores that are encased by an inner jacket, a strength member layer, and an outer jacket. The conductor layer can also include compression-resistant members that have larger outer diameters than the outer diameters of the conductors.

In another non-limiting embodiment, the gun cable can have a conductor layer that includes cable elements that have optical fiber cores or min-quad cores, and each of the optical fiber cores and min-quad cores can have an inner jacket, a strength member layer, and an outer jacket located thereabout.

The conductor layer can also include conductors that have a core that includes conductive elements formed from copper/magnesium alloy or steel-clad copper, and the cores can have an outer jacket located thereabout. The conductor layer can also include compression-resistant members that have a larger outer diameter than the outer diameter of the cable elements.

In another non-limiting embodiment, the gun cable can have a conductor layer that includes cable elements that have mini-quad cores, optical fiber cores, and conductors with cores having a conductive element made from copper-clad steel or copper/magnesium alloy. The mini-quad cores can have conductive elements made from copper/magnesium alloy or copper-clad steel.

The cable elements with the mini-quad cores and optical fiber cores can have an outer jacket and reinforcement jacket located thereabout or an inner conductor jacket, a strength member layer, and an outer jacket located thereabout.

The conductor layer can also include compression-resistant members that have outer diameters that are substantially equal to the outer diameters of the cable elements or compression-resistant members that have larger outer diameters than the outer diameters of the cable elements.

The gun cables disclosed herein can have an outer cable jacket with armor wire, reinforcing fibers, or the like. The armor wire can be made from steel or the other suitable materials. The reinforcing fibers can be fiberglass, carbon fibers, or the like.

The gun cables disclosed herein can also include a protection layer located between the hose and the conductor layer and another protection layer located between the conductor layer and the outer cable jacket. The protection layers can allow the conductors to move relative to the hose and the outer cable jacket. The protection layers can be aramid fiber or other suitable materials.

An example method of making a gun-cable for use in seismic marine operations includes placing conductors about an internal hose. At least one of the conductors is resistant to compression. The method can also include placing compression-resistant members adjacent to some of the cable elements. The compression-resistant members and cable elements form a conductor layer. The method can also include placing an outer cable jacket about the conductor layer.

The method can also include placing a protection layer between the hose and the conductor layer. The protection layer can be an aramid fiber layer. The aramid fiber layer can allow the conductor layer to move.

The method can also include placing another protection layer between the hose and the outer cable jacket. This protection layer can be an aramid fiber layer, and can allow the conductor layer to move.

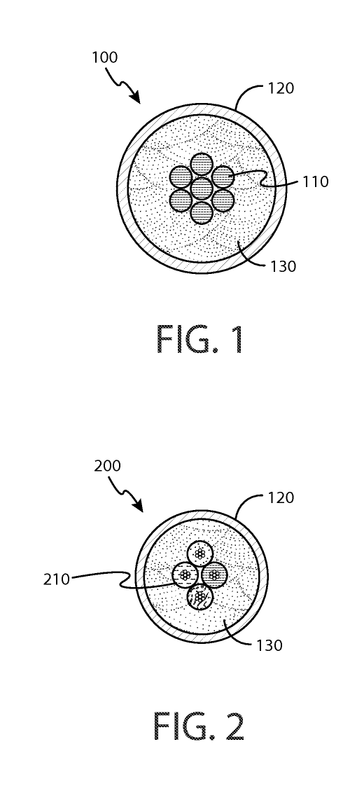

FIG. 1 depicts an embodiment of a cable element that is resistant to compression.

The cable element 100 that is resistant to compression includes a core 110. The core 110 has an outer reinforcement jacket 120 and an outer conductor jacket 130 disposed thereabout.

The core 110 can include stranded copper wire conductive elements, copper-clad steel conductive elements, copper/magnesium alloy conductive elements, or other suitable types of conductive elements. The outer reinforcement jacket 120 can be made from steel or other suitable materials.

The cable element 100 can be formed by positioning the core 110 at a desired location and extruding the polymeric outer jacketing 130 about the core 110. The core 110 and polymeric outer jacketing 130 can then be placed relative to a strip of material such that when the strip is roll formed into a tube, the core 110 and the outer conductor jacket 130 are located within an inner bore of the tube. The tube can then be seam welded and drawn down over the polymeric jacketing 130, forming the cable element 100.

FIG. 2 depicts another embodiment of a cable element that is resistant to compression.

The cable element 200 that is resistant to compression includes a core 210, an outer conductor jacket 130, and an outer reinforcement jacket 120.

The core 210 is depicted as a mini-quad core that has four conductive elements. The conductive elements can be made from any conductive material. Illustrative materials can include copper, copper-clad steel, magnesium/copper alloy, or like materials.

The cable element 200 can be formed by placing the core 210 at a desired location and extruding a polymeric material about the core 210. The core 210 with the outer jacketing 130 can be placed relative to a metal strip. The metal strip is formed into a tube, and the core 210 and outer conductor jacket 130 are located in an inner bore of the tube. The tube can be seam welded and drawn down about the outer conductor jacket 130, providing a reinforcement jacket 120 located about the core 210.

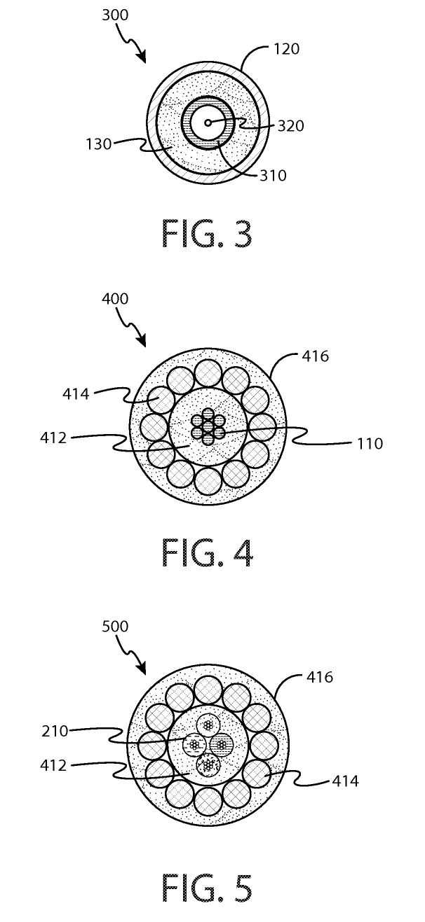

FIG. 3 depicts another embodiment of a cable element that is resistant to compression.

The cable element 300 that is resistant to compression includes a core 310. The core 310 is depicted as a shaped conductive element tube 312 with an optical fiber 320 located therein. The shaped conductive element tube 312 can be a shaped-copper wire tube or other acceptable type of tube. The core 310 has the outer conductor jacket 130 and reinforcement jacket 120 disposed thereabout.

The cable element 300 can be formed by placing the core 310 at a desired location and extruding the outer conductor jacket 130 about the core 310. The core 310 and the outer conductor jacket 130 can be placed relative to a metal strip, allowing the core 310 and outer conductor jacket 130 to be located within an inner bore of a tube formed by the metal strip. The tube can be seam welded, and the tube can be drawn down about the outer conductor jacket, forming the conductor 300 having a core 310 with an outer conductor jacket 130 and reinforcement jacket 120 disposed thereabout.

The core 310 can include a plurality of optical fibers 320 located in the shaped conductive element tube 312. In an embodiment, the core 310 can include a plurality of shaped conductive element tubes 312. Each of the shaped conductive element tubes 312 can have any number of optical fibers located therein.

FIG. 4 depicts yet another embodiment of a cable element that is resistant to compression.

The cable element 400 has a core 110. The core 110 can have an inner conductor jacket 412, a strength member layer 414, and outer conductor jacket 416.

The inner conductor jacket 412 can be made from any suitable material. For example, the inner conductor jacket 412 can be made from a polymeric material.

The strength member layer 414 can include aramid yarn strength members, reinforced nylon strength members, or other suitable strength members.

The outer conductor jacket 416 can be made from any suitable material. For example, the outer conductor jacket 416 can be made from a hard polymer.

The cable element 400 can be made by placing the core 110 in a desired location and extruding the inner conductor jacket 412 about the core 110. The strength member layer 414 can be placed about the inner conductor jacket 412. For example, aramid yarn strength members can be placed about the inner conductor jacket 412. The outer conductor jacket 416 can be placed about the strength member layer 414, providing the cable element 400 that has the core 110 with an inner conductor layer 412, the strength member layer 414, and the outer conductor jacket 416 disposed thereabout.

FIG. 5 depicts another embodiment of a cable element that is resistant to compression.

The cable element 500 includes the core 210, the inner conductor jacket 412, the strength member layer 414, and the outer conductor jacket 416.

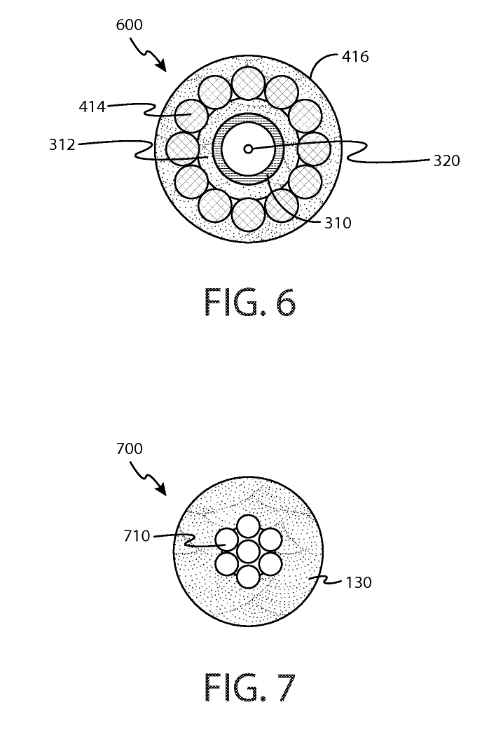

FIG. 6 depicts another embodiment of a cable element that is resistant to compression.

The cable element 600 includes the core 310, the strength member layer 414, and the outer conductor jacket 416.

The core 310 can include any number of optical fibers 320 located in the shaped conductive element tube 312. For example, one optical fiber 320 can be located in the shaped conductive element tube 312. In another example, ten optical fibers 320 can be located in the shaped conductive element tube 312.

In an embodiment the core 310 can include a plurality of shaped conductive element tubes 312. Each of the shaped conductive element tubes 312 can have any number of optical fibers 320 located therein. For example, the core 310 can include four conductive element tubes 312, and each of the conductive element tubes 312 can have an optical fiber 320 located therein.

FIG. 7 depicts another embodiment of a cable element that is resistant to compression.

The cable element 700 can include a single conductive element 710 encased by an outer conductor jacket 130. The single conductive element 710 can be a copper-clad steel conductor, a copper/magnesium alloy, or the like.

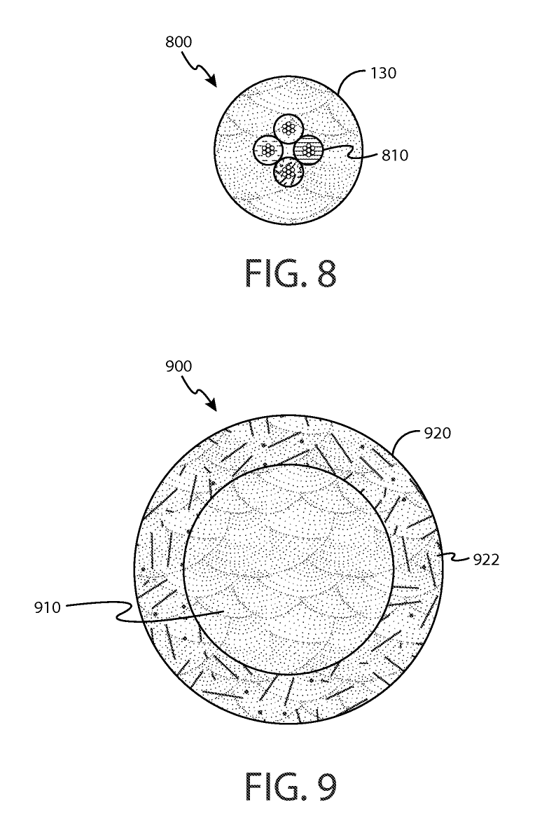

FIG. 8 depicts another embodiment of a cable element that is resistant to compression.

The cable element 800 can include a mini-quad core 810. The mini-quad core 810 can have copper-clad, copper/magnesium alloy, or similar conductive elements. The outer conductor jacket 130 is located about the mini-quad core 810.

FIG. 9 depicts an embodiment of a compression-resistant member.

The compression-resistant member 900 includes a member core 910. The member core 910 can be made from any material that has strong compression strength. For example, the member core 910 can be made from a high-density polyethylene.

A member outer layer 920 is located about the member core 910. The member outer layer 920 can be made from any suitable material. Illustrative materials include high-density polyethylene, nylon, or the like.

Reinforcement fibers 922 can be located in the member outer layer. The reinforcement fibers 922 can include carbon fibers, glass fibers, metal fibers, or other suitable fibers.

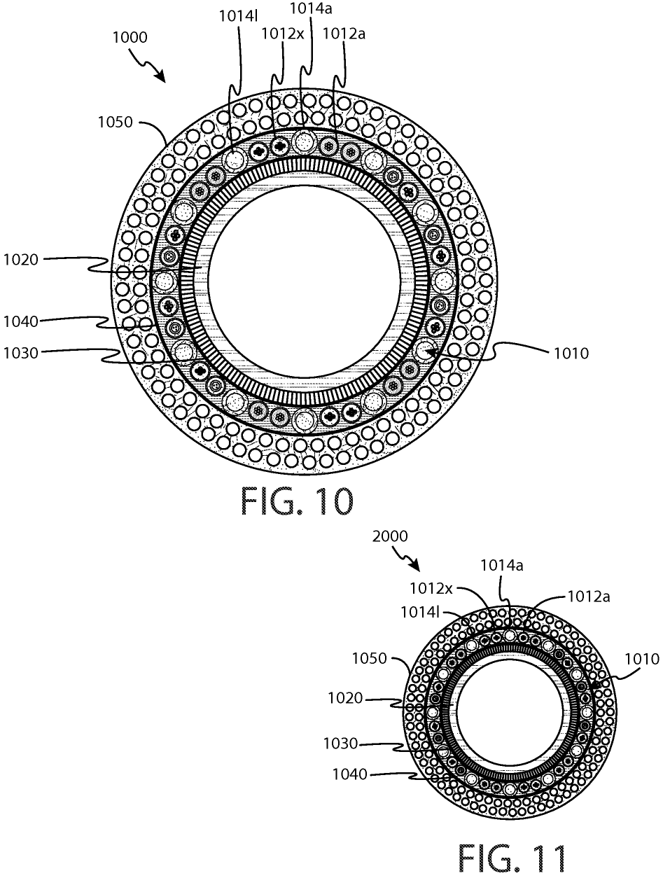

FIG. 10 depicts an embodiment of a gun cable.

The gun cable 1000 includes a hose 1020, a conductor layer 1010, an inner protection layer 1030, an outer protection layer 1040, and an outer cable jacket 1050.

The conductor layer 1010 includes a plurality of conductors 1012a to 1012x. The conductors 1012a to 1012x can include the conductors resistant to compression disclosed herein. The conductor layer 1010 also includes other conductors, such as mini-quad conductor 1012a. The mini-quad conductor 1012a does not have a reinforcement jacket. The conductor layer can also include optical fiber elements that do not have a reinforcement jacket. In some embodiments, some of the conductors 1012a to 1012x can include now known or future known conductors.

The conductor layer 1010 also includes a plurality of compression-resistant members 1014a to 1014l. The compression-resistant members can be any of those disclosed herein. The outer diameters of the compression-resistant members 1014a to 1014l are substantially similar to the outer diameters of the conductors 1012a to 1012x.

The outer cable jacket 1050 includes a plurality of strength members. The strength members can be armor wire or the like. The outer cable jacket 1050 can be made from a polymeric material or the like.

FIG. 11 depicts another embodiment of a gun cable.

The gun cable 2000 includes a hose 1020, a conductor layer 2010, an inner protection layer 1030, an outer protection layer 1040, and an outer cable jacket 1050.

The conductor layer 2010 includes a plurality of cable elements 1012a to 1012x. The cable elements 1012a to 1012x can be any combination of conductors resistant to compression that are disclosed herein. In some embodiments, some of the cable elements 1012a to 1012x can include now known or future known conductors. Some of the cable elements 1012a to 1012x can be conductors without an outer reinforcement jacket. For example, some of the cable elements 1012a to 1012x can be min-quad conductors without reinforcement jackets and optical fiber elements without reinforcement jackets.

The conductor layer 2010 also includes a plurality of compression-resistant members 1014a to 1014l. The compression-resistant members 1014a to 1014l can be any of those disclosed herein. The compression-resistant members 1014a to 1014l can have outer diameters that are larger than the outer diameters of the cable elements 1012a to 1012x.

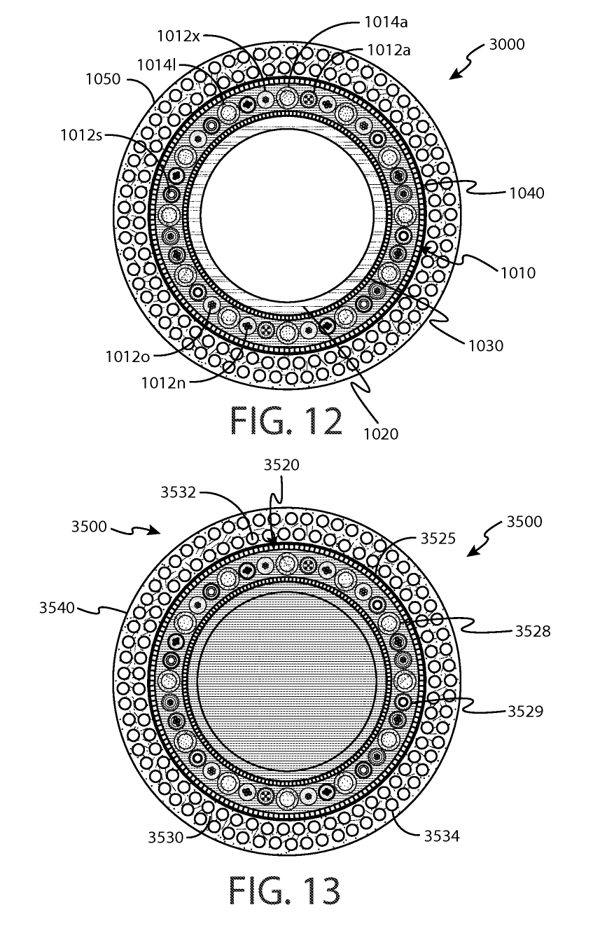

FIG. 12 depicts yet another embodiment of a gun cable.

The gun cable 3000 includes a hose 1020, a conductor layer 3010, an inner protection layer 1030, an outer protection layer 1040, and an outer cable jacket 1050.

The conductor layer 3010 includes a plurality of cable elements 1012a to 1012x. The cable elements 1012a to 1012x can include any combination of conductors, disclosed herein, that are resistant to compression. Some of the conductors can be now known or future known conductors. For example, as depicted, the conductor layer 3010 includes conductors that have a core with an inner conductor jacket, a strength layer, and outer conductor jacket disposed thereabout, such as first conductor 1012a. The conductor layer also includes conductors with a core that is a copper-clad steel, and the core has an outer conductor jacket disposed thereabout, such as fifteenth conductor 1012n. The conductor layer 3010 also includes conductors with a mini-quad core that has conductive elements made from copper/magnesium, copper-clad steel, or the like, such as fourteenth conductor 1012o. The conductor layer 3010 also includes cable elements having a fiber optic core with an outer conductor jacket and reinforcement jacket disposed thereabout; such as nineteenth conductor 1012s.

FIG. 13 depicts an embodiment of a cable.

The cable 3500 includes a cable element layer 3520. The cable element layer 3520 includes a plurality of cable elements 3529, which can be any type of cable element disclosed herein. The cable element layer 3520 also includes a plurality of compression resistant members 3528. The compression resistant members can be similar to those disclosed herein. The compression resistant members 3528 and the cable elements 3529 can be disposed in a polymeric material 3525.

The cable 3500 also has an outer cable jacketing 3540. The outer cable jacket 3540 includes two strength member layers 3532 and 3534. The strength member layers 3532 and 3534 are integrated with polymeric material 3530 that can be bonded with the polymeric material 3525 of the cable element layer.

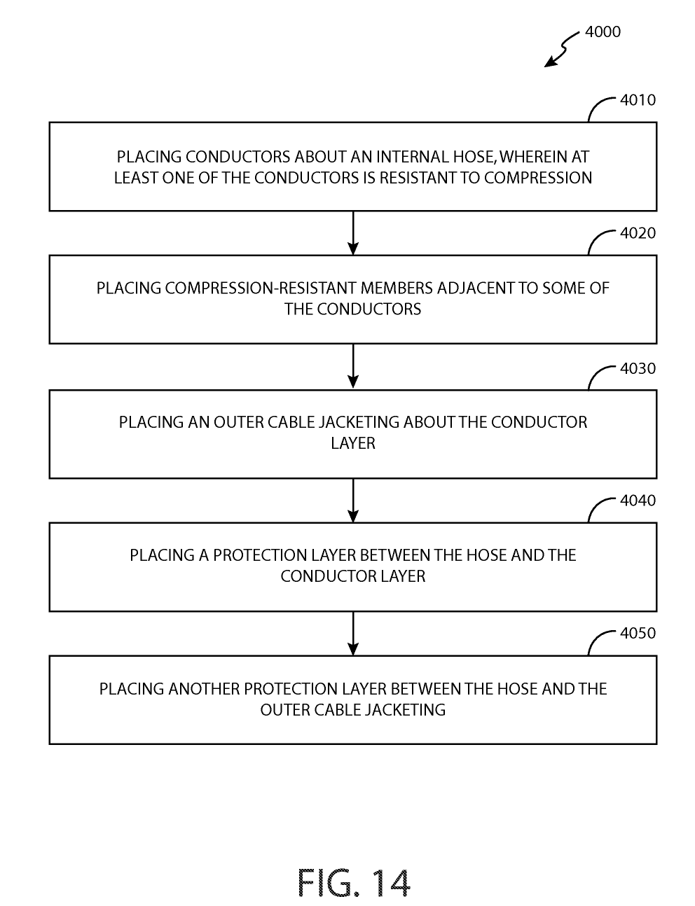

FIG. 14 depicts an embodiment of a method of making a gun-cable for use in seismic marine operations.

The method 4000 is depicted as a series of operations or blocks.

A method 4000 includes placing cable elements about an internal hose, wherein at least one of the cable elements is resistant to compression (Block 4010). The method also includes placing compression-resistant members adjacent to some of the conductors (Block 4020). The compression-resistant members and conductors form a conductor layer.

The method also includes placing an outer cable jacketing about the conductor layer (Block 4030).

The method further includes placing a protection layer between the hose and the conductor layer (Block 4040), and placing another protection layer between the hose and the outer cable jacketing (Block 4050).

Although example assemblies, methods, systems have been described herein, the scope of coverage of this patent is not limited thereto. On the contrary, this patent covers every method, apparatus, and article of manufacture fairly falling within the scope of the appended claims either literally or under the doctrine of equivalents.

What is claimed is:

1. A gun-cable for use in marine-seismic activities, wherein the gun-cable comprises:
a hose;
an outer cable jacketing located about the hose; and
a conductor layer located between the hose and the outer cable jacketing, wherein the conductor layer comprises:
cable elements that are resistant to compression; and
a plurality of compression-resistant members.

2. The gun-cable of claim 1, wherein the compression-resistant members of the plurality of compression-resistant members comprise a member core of high-density polyethylene and a member outer layer made of high-density polyethylene with reinforcement fibers.

3. The gun-cable of claim 1, wherein the compression-resistant members of the plurality of compression-resistant members comprise a member core of high-density polyethylene and a member outer layer made of nylon and reinforcement fibers.

4. The gun-cable of claim 1, wherein at least one of the cable elements comprises a core with an outer conductor jacket and a reinforcing jacket disposed thereabout.

5. The gun-cable of claim 4, wherein the core comprises an optical fiber disposed in a tube.

6. The gun-cable of claim 1, wherein the cable element comprises a mini-quad core.

7. The gun-cable of claim 1, wherein at least one of the cable elements comprises a core with an inner conductor jacket, a strength layer, and an outer conductor jacket disposed thereabout.

8. The gun-cable of claim 1, wherein each of the compression-resistant members of the plurality of compression-resistant members has an outer diameter that is larger than an outer diameter of each of the cable elements.

9. The gun-cable of claim 1, wherein each of the compression-resistant members of the plurality of compression-resistant members has an outer diameter that is substantially equal to an outer diameter of each of the cable elements.

10. A method of making a gun-cable for use in seismic marine operations, wherein the method comprises:
placing cable elements about an internal hose, wherein at least one of the cable elements is resistant to compression;
placing compression-resistant members adjacent to the cable elements, wherein the compression-resistant members and cable elements form a conductor layer; and
placing an outer cable jacketing about the conductor layer.

11. The method of claim 12, further comprising:
placing a protection layer between the hose and the conductor layer.

12. The method of claim 12, further comprising:
placing another protection layer between the hose and the outer cable jacketing.

13. The method of claim 12, wherein each of the compression-resistant members has an outer diameter that is larger than an outer diameter of each of the conductors.

14. The method of claim 12, wherein each of the compression-resistant members has an outer diameter that is substantially equal to an outer diameter of each of the conductors.

15. A cable comprising:
a conductor layer, wherein the conductor layer comprises:
cable elements that are resistant to compression; and
a plurality of compression-resistant members; and
an outer cable jacketing located about conductor layer.
